(19) United States
(12) Patent Application Publication
(10) Pub. No.: US 2019/0045825 A1
(43) Pub. Date: Feb. 14, 2019

(54) GRANULATED PRODUCT AND METHOD FOR MANUFACTURING SAME

(71) Applicant: AJINOMOTO CO., INC., Tokyo (JP)

(72) Inventors: Hiroto MUKOUYAMA, Kawasaki-shi (JP); Susumu Yamaguchi, Kawasaki-shi (JP)

(73) Assignee: AJINOMOTO CO., INC., Tokyo (JP)

(21) Appl. No.: 16/163,801

(22) Filed: Oct. 18, 2018

Related U.S. Application Data
(63) Continuation of application No. PCT/JP2017/015549, filed on Apr. 18, 2017.

(30) Foreign Application Priority Data
Apr. 19, 2016 (JP) 2016-083727

(51) Int. Cl. A23L 27/00; A23L 33/175; A23P 20/10

(52) U.S. Cl. CPC A23L 27/88; A23L 27/86; A23L 33/175; A23V 2300/31; A23V 2002/00; A23V 2200/16; A23V 2250/06; A23P 20/11

(57) ABSTRACT

A bitter taste of a bitter taste ingredient such as a branched chain amino acid may be suppressed (reduced) by forming a granulated product by mixing a raw material core particle containing a bitter taste ingredient and a coating material by stirring at a temperature not lower than the melting point of the coating material.

### CROSS REFERENCES TO RELATED APPLICATIONS

This application is a continuation of International Patent Application No. PCT/JP2017/015549, filed on Apr. 18, 2017, and claims priority to Japanese Patent Application No. 2016-083727, filed on Apr. 19, 2016, both of which are incorporated herein by reference in their entireties.

### BACKGROUND OF THE INVENTION

### Field of the Invention

The present invention relates to granulated products and methods for producing the same. The present invention relates to, in particular, granulated products and methods for producing the same useful for suppressing (reducing) a bitter taste of a bitter taste ingredient such as a branched chain amino acid.

### Discussion of the Background

As a technique for masking a foreign taste such as bitter taste, there is known a method of coating an ingredient that shows a foreign taste such as bitter taste with such an ingredient as a coating material. Specifically, there is known, for example, a method for obtaining a coated preparation in which an unpleasant taste is suppressed, which comprises heat-treating uncoated granules containing a pharmaceutical compound and a wax-like substance, and adding a powdered wax-like substance to the granules at a temperature at which the wax-like substance wets the surfaces of the particles to give thermofusion coating to the surfaces of the uncoated granules (see WO 2005/039538, which is incorporated herein by reference in its entirety). In such a technique, in order to secure ease of oral ingestion while masking a foreign taste, it is required to make the mean particle diameter of the coated product be within a predetermined range, and make the particle size distribution of the coated product uniform at the same time. That is, an unduly large particle diameter gives bad feeling when they pass through the throat, an unduly small particle diameter causes choking, and the both result in difficulty of ingestion. In addition, if the particle diameter is too small, coating becomes insufficient, and therefore masking of a foreign taste may become insufficient. However, it is difficult to manufacture a coated product having an objective mean particle diameter and particle size distribution. Therefore, particles of an objective particle size have conventionally been obtained by subjecting a coated product to a fractionation means such as sieving.

There is also known a method for obtaining spherical granulated product showing a narrow particle size distribution by granulating raw material particles and a binder of which melting point is 50 to 90° C. under ordinary temperature, heating the granulated product at a temperature in the range of from the melting point of the binder to a temperature higher by 30° C. than the melting point to melt the binder, and solidifying it by cooling (see Japanese Patent Laid-open (Kokai) No. 2009-262061, which is incorporated herein by reference in its entirety).

### SUMMARY OF THE INVENTION

Accordingly, it is one object of the present invention to provide novel granulated products.

It is another object of the present invention to provide novel methods for producing such a granulated product.

It is another object of the present invention to provide a method for suppressing (reducing) a bitter taste of a bitter taste ingredient such as a branched chain amino acid.

These and other objects, which will become apparent during the following detailed description, have been achieved by the inventors' discovery that by forming a granulated product by mixing a raw material core particle and an oil or fat by stirring at a temperature higher than the melting point of the oil or fat, the raw material core particle containing a bitter taste ingredient such as a branched chain amino acid and the oil or fat being a solid or semi-solid at ordinary temperature, a bitter taste of the bitter taste ingredient such as a branched chain amino acid can be suppressed (reduced).

Thus, the present invention provides the following:

(1) A granulated product having the following characteristics (A) and (B):

(A) mean particle diameter D50 is 50 μm or larger;

(B) non-uniformity of particle diameter D90/D10 is 14.998×(D50 (μm)−49)^{-0.295} or lower.

(2) The granulated product mentioned above, which contains a bitter taste ingredient.

(3) The granulated product mentioned above, which contains a coating material.

(4) The granulated product mentioned above, wherein the bitter taste ingredient is coated with the coating material.

(5) The granulated product mentioned above, wherein the bitter taste ingredient is an amino acid.

(6) The granulated product mentioned above, wherein the coating material consists of one or more kinds of ingredients selected from an oil or fat having a melting point of 20° C. or higher and an emulsifier having a melting point of 20° C. or higher.

(7) The granulated product mentioned above, wherein the contained amount of the bitter taste ingredient in the granulated product is 30% (w/w) or higher.

(8) The granulated product mentioned above, wherein the contained amount of the coating material in the granulated product is 2 to 30% (w/w).

(9) The granulated product mentioned above, wherein non-uniformity of particle diameter D90/D10 is 14.998×D50 (μm)^{-0.307} or lower.

(10) A method for producing a granulated product, which comprises:

(A) mixing a raw material core particle and a coating material by stirring at a temperature not lower than the melting point of the coating material.

(11) The method mentioned above, wherein the raw material core particle contains a bitter taste ingredient.

(12) The method mentioned above, wherein the contained amount of the bitter taste ingredient in the raw material core particle is 30% (w/w) or higher.

(13) The method mentioned above, wherein the bitter taste ingredient is an amino acid.

(14) The method mentioned above, wherein the coating material consists of one or more kinds of ingredients selected from an oil or fat having a melting point of 20° C. or higher and an emulsifier having a melting point of 20° C. or higher.

(15) The method mentioned above, wherein the amount of the raw material core particle used is 80% (w/w) or larger in terms of a weight ratio based on the total amount of the raw materials of the granulated product.

(16) The method mentioned above, wherein the amount of the coating material to be used in terms of a weight ratio based on the total amount of the raw materials of the granulated product is 2 to 30% (w/w) when mean particle diameter D50 of the raw material core particle is 75 μm or smaller, or 2 to 10% (w/w) when the mean particle diameter D50 of the raw material core particle is larger than 75 μm.

(17) The method mentioned above, which comprises:

(B) mixing the raw material core particle and the coating material at a temperature lower than the melting point of the coating material prior to step A.

(18) The method mentioned above, wherein the temperature is increased during step B.

(19) The method mentioned above, wherein the period of stirring performed in the step A is 2 to 150 minutes.

(20) The method mentioned above,

wherein step A is performed by using a stirring machine provided with a stirrer, and

wherein the stirring speed used in step A in terms of circumferential speed of the stirrer is 10 to 20 m/s when the volume of the stirring machine is 3 L or smaller, 4 to 12 m/s when the volume of the stirring machine is larger than 60 L, or 4 to 20 m/s when the volume of the stirring machine is larger than 3 L and not larger than 60 L.

(21) The granulated product mentioned above, wherein the amino acid is a branched chain amino acid.

(22) The granulated product mentioned above, wherein the amino acid consists of one or more kinds of amino acids selected from L-valine, L-leucine, and L-isoleucine.

(23) The granulated product mentioned above, wherein the mean particle diameter D50 is 50 to 1200 μm.

(24) The granulated product mentioned above, wherein the coating material is hydrogenated vegetable oil.

(25) The method mentioned above, wherein the amino acid is a branched chain amino acid.

(26) The method mentioned above, wherein the amino acid consists of one or more kinds of amino acids selected from L-valine, L-leucine, and L-isoleucine.

(27) The method mentioned above, wherein the coating material is hydrogenated vegetable oil.

(28) The method mentioned above, which is performed by using a stirring granulation machine.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1(A) and FIG. 1(B) are graphs showing correlation of D50 and D90/D10. FIG. 1(A) shows correlation observed when a raw material core particle having a mean particle diameter D50 smaller than 50 μm was used, and FIG. 1(B) shows correlation observed when a raw material core particle having a mean particle diameter D50 of 100 μm or larger was used.

FIG. 2 is a graph showing correlation of D50 and D90/D10.

### DETAILED DESCRIPTION OF THE PREFERRED EMBODIMENTS

Hereafter, the present invention will be explained in detail.

### 1. Method of the Present Invention

The method of the present invention is a method for producing a granulated product, which comprises a step A of mixing a raw material core particle and a coating material by stirring at a temperature not lower than the melting point of the coating material.

In the method of the present invention, the granulated product may be or may not be produced only from the raw material core particle and the coating material. That is, in the method of the present invention, the granulated product may be produced from the raw material core particle, the coating material, and another ingredient. The raw materials of the granulated product, i.e., the raw material core particle, the coating material, and the other ingredient are generically referred to as “raw materials” (the other ingredient is included only when it is used).

Specifically, the granulated product produced by the method of the present invention may be the raw material core particle coated with the coating material. In one granule of the granulated product produced by the method of the present invention, one particle of the raw material core particle may be contained, or two or more particles of the raw material core particle may be contained. That is, for example, one particle of the raw material core particle may be coated with the coating material to form one granule of the granulated product, or two or more particle of the raw material core particle may be coated together with the coating material to form one granule of the granulated product. When the raw material core particle is a particle containing a bitter taste ingredient, the granulated product produced by the method of the present invention may be, specifically, a granulated product in which the bitter taste of the raw material core particle, i.e., the bitter taste of the bitter taste ingredient contained in the raw material core particle, is suppressed (reduced). Specifically, the granulated product produced by the method of the present invention may be the granulated product of the present invention explained later.

According to the method of the present invention, an effect of enhancing uniformity of the particle diameter of the granulated product can be obtained. That is, according to the method of the present invention, a granulated product showing a high uniformity of the particle diameter (i.e., showing sharp particle size distribution) can be obtained. The granulated product produced by the method of the present invention may have, for example, such a non-uniformity of particle diameter D90/D10 of the granulated product of the present invention as described later. The granulated product produced by the method of the present invention may have, for example, such a mean particle diameter D50 of the granulated product of the present invention as described later.

According to the method of the present invention, when the raw material core particle is a particle containing a bitter taste ingredient, there can be obtained an effect of suppressing (reducing) a bitter taste of the raw material core particle, i.e., the bitter taste of the bitter taste ingredient contained in the raw material core particle. This effect is also referred to as “bitter taste-suppressing effect”. That is, one embodiment of the method of the present invention may be a method for suppressing a bitter taste of a bitter taste ingredient, which comprises the step A. The term “suppression (reduction) of a bitter taste” means that intensity of a bitter taste in a granulated product produced by the method of the present invention is lower than that of a control material. Examples of the control material include the raw material core particle as it is, and a granulated product produced by mixing the raw material core particle and the coating material by stirring under conditions not falling within the conditions of the step A of the method of the present invention. Intensity of a bitter taste can be determined by, for example, an organoleptic evaluation performed by special panelists.

### Raw Material Core Particle

The raw material core particle is a particle containing a desired ingredient. The type of the ingredient contained in the raw material core particle is not particularly limited so long as the desired effect can be obtained. The type of the ingredient contained in the raw material core particle can be appropriately determined depending on various conditions such as use of the granulated product produced by the method of the present invention. The raw material core particle may be, for example, a particle containing a bitter taste ingredient. The raw material core particle may or may not consist of a bitter taste ingredient. That is, the raw material core particle may consist of a combination of a bitter taste ingredient and another ingredient. The contained amount of the bitter taste ingredient in the raw material core particle, for example, may be 30% (w/w) or higher, 50% (w/w) or higher, 70% (w/w) or higher, 80% (w/w) or higher, 90% (w/w) or higher, 95% (w/w) or higher, or 97% (w/w) or higher, may be 100% (w/w) or lower, or 99% (w/w) or lower, or may be within a range defined by a combination of the foregoing ranges.

The term “bitter taste ingredient” refers to an ingredient that shows a bitter taste. The type of the bitter taste ingredient is not particularly limited so long as the bitter taste-suppressing effect can be obtained. That is, as the bitter taste ingredient, any bitter taste ingredient for which reduction of a bitter taste is desired can be chosen. Examples of the bitter taste ingredient include bitter taste ingredients to be blended in foods, drinks, seasonings, or drugs. Examples of the bitter taste ingredient include, for example, amino acids, tannin, catechin, and caffeine. Specific examples of the amino acids that show a bitter taste include, for example, branched chain amino acids (BCAAs) such as valine, leucine, and isoleucine; aromatic amino acids such as phenylalanine, tryptophan, and tyrosine; methionine, arginine, histidine, and ornithine. As the bitter taste ingredient, amino acids are especially preferred, and BCAAs are more preferred. As the bitter taste ingredient, one kind of ingredient may be used, or two or more kinds of ingredients may be used in combination. For example, two or more kinds of ingredients selected from BCAAs, for example, all of valine, leucine, and isoleucine, may be used as the bitter taste ingredient. When two or more kinds of ingredients are used as the bitter taste ingredient, two or more kinds of the ingredients may or may not coexist in each single particle (in one particle of the raw material core particle).

For the present invention, all the amino acids are L-isomers, unless especially indicated. For the present invention, the amino acids may be a free compound, a salt, or a mixture of these. That is, the term “amino acid” means an amino acid as a free compound, a salt thereof, or a mixture of them, unless especially indicated. These amino acids (for example, free compounds and salts) may include an anhydride and hydrate thereof, unless especially indicated.

The salt is not particularly limited so long as it can be orally ingested. Specific examples include, as salts of acidic group such as carboxyl group, for example, ammonium salts, salts with an alkali metal such as sodium and potassium, salts with an alkaline earth metal such as calcium and magnesium, aluminum salts, zinc salts, salts with an organic amine such as triethylamine, ethanolamine, morpholine, pyrrolidine, piperidine, piperazine, and dicyclohexylamine, and salts with a basic amino acid such as arginine and lysine. Specific examples also include, as salts of basic group such as amino group, for example, salts with an inorganic acid such as hydrochloric acid, sulfuric acid, phosphoric acid, nitric acid, and hydrobromic acid, salts with an organic carboxylic acid such as acetic acid, citric acid, benzoic acid, maleic acid, fumaric acid, tartaric acid, succinic acid, tannic acid, butyric acid, hibenzic acid, pamoic acid, enanthic acid, decanoic acid, teoclic acid, salicylic acid, lactic acid, oxalic acid, mandelic acid, malic acid, methylmalonic acid, and adipic acid, and salts with an organic sulfonic acid such as methanesulfonic acid, benzenesulfonic acid, and p-toluenesulfonic acid. As the salt, one kind of salt may be used, or two or more kinds of salts may be used in combination.

As the bitter taste ingredient or the raw material core particle containing it, a commercial product may be used, or those obtained by appropriately producing them may be used.

A bitter taste ingredient can be produced by a conventional method. A bitter taste ingredient can be produced by, for example, an extraction method, enzymatic method, fermentation method, chemical synthesis method, or a combination of these. For example, a bitter taste ingredient such as BCAA can be produced by culturing a microorganism having an ability to produce the bitter taste ingredient, and collecting the bitter taste ingredient from the culture broth or cells (fermentation method). Specifically, a bitter taste ingredient such as BCAA can be produced by, for example, the method described in European Patent No. 0 872 547, European Patent No. 1 942 183, or European Patent Publication No. 2 218 729, all of which are incorporated herein by reference in their entireties. A bitter taste ingredient can also be produced by, for example, collecting it from an agricultural, fishery, or livestock product containing the bitter taste ingredient. The bitter taste ingredient may be purified to a desired extent.

The bitter taste ingredient can be used as the raw material core particle, for example, as it is, or after being appropriately processed. A fraction containing a bitter taste ingredient can also be used as the raw material core particle, for example, as it is, or after being appropriately processed. Specific examples of such a fraction containing a bitter taste ingredient include, for example, fermentation products such as culture broth, cells, and culture supernatant produced by culturing a microorganism having an ability to produce the bitter taste ingredient such as BCAA, and processed products of them. A bitter taste ingredient or a fraction containing it may be processed so that, for example, a desired mean particle diameter D50 are obtained, and then used as the raw material core particle. A bitter taste ingredient or a fraction containing it may be used independently as the raw material core particle, or in combination with another ingredient as the raw material core particle. The raw material core particle containing a bitter taste ingredient can be produced from a bitter taste ingredient or a fraction containing it by, for example, extraction, concentration, drying, crystallization, grinding, granulation, or a combination of these. For example, a fermentation product such as culture broth produced by culturing a microorganism having an ability to produce a bitter taste ingredient such as BCAA may be granulated in a state that it contains cells of the microorganism, and used as the raw material core particle. Further, for example, a crystal of a bitter taste ingredient such as BCAA or a material containing it may be ground so that a desired mean particle diameter D50 is obtained, and used as the raw material core particle. The grinding can be performed by, for example, using a grinding machine. Such a grinding machine is not particularly limited so long as an object can be ground to a desired extent. Examples of the grinding machine include, for example, various mills such as pin mill, jet mill, feather mill, rod mill, ball mill, vibration rod mill, vibration ball mill, and disk mill, various crushers such as jaw crusher, gyratory crusher, cone crusher, smooth roll crusher, toothed roll crusher, impact crusher, and hammer crusher, food cutter, and dicer. Specific examples of hammer crusher include, for example, Pulverizers (AP-1, AP-4TH etc., Hosokawa Micron).

The type of the other ingredient (ingredient other than the bitter taste ingredient) contained in the raw material core particle is not particularly limited so long as a desired effect (for example, bitter taste-suppressing effect) can be obtained. Examples of the other ingredient contained in the raw material core particle include ingredients to be blended in foods, drinks, seasonings, or drugs. Specific examples of such ingredients include, for example, inorganic salts, organic acids and salts thereof, amino acids and salts thereof, nucleic acids and salts thereof, dietary fibers, pH buffering agents, excipients, fillers, perfumes (flavor ingredients), and edible oils. The raw material core particle may contain one kind of ingredient or two or more kinds of ingredients as the other ingredient (ingredient other than the bitter taste ingredient). When two or more kinds of ingredients are used as the other ingredient (ingredient other than the bitter taste ingredient), two or more kinds of the ingredients may or may not coexist in a single particle (in one particle of the raw material core particle).

The shape of the raw material core particle is not particularly limited so long as a desired effect (for example, bitter taste-suppressing effect) can be obtained. The raw material core particle may be in any shape such as spherical shape or polyhedral shape. The raw material core particle may be in, for example, a crystal shape that can be taken by the bitter taste ingredient depending on the type thereof. The size of the raw material core particle is not particularly limited so long as a desired effect (for example, bitter taste-suppressing effect) can be obtained. The size of the raw material core particle can be appropriately determined according to various conditions such as the conditions of the step A. The mean particle diameter D50 of the raw material core particle, for example, may be 0.1 μm or larger, 0.5 μm or larger, 1 μm or larger, 5 μm or larger, 10 μm or larger, 20 μm or larger, 30 μm or larger, 50 μm or larger, 75 μm or larger, 100 μm or larger, 150 μm or larger, or 200 μm or larger, may be 300 μm or smaller, 250 μm or smaller, 200 μm or smaller, 150 μm or smaller, 120 μm or smaller, 100 μm or smaller, 75 μm or smaller, 60 μm or smaller, 50 μm or smaller, smaller than 50 μm, 45 μm or smaller, or 40 μm or smaller, or may be within a range defined by an uncontradictory combination of the foregoing ranges. Specifically, the mean particle diameter D50 of the raw material core particle may be, for example, 0.1 to 300 μm, 1 to 200 μm, 10 to 120 μm, not smaller than 0.1 μm and smaller than 50 μm, not smaller than 1 μm and smaller than 50 μm, or not smaller than 10 μm and smaller than 50 μm. The term “mean particle diameter D50” will be explained later.

### Coating Material

The type of the coating material is not particularly limited so long as a desired effect (for example, bitter taste-suppressing effect) can be obtained. Examples of the coating material include oils, fats, and emulsifiers. The coating material may be a material that is a solid or semi-solid at ordinary temperature (for example, at 20° C.). The melting point of the coating material, for example, may be 20° C. or higher, 25° C. or higher, 30° C. or higher, 40° C. or higher, 50° C. or higher, or 60° C. or higher, may be 90° C. or lower, 80° C. or lower, 70° C. or lower, or 60° C. or lower, or may be within a range defined by an uncontradictory combination of the foregoing ranges. Specifically, the melting point of the coating material may be, for example, 20 to 70° C., or 40 to 70° C. As the coating material, one kind of ingredient may be used, or two or more kinds of ingredients may be used in combination.

Examples of oils and fats include oils and fats derived from animals (animal fats and oils), oils and fats derived from plants (vegetable oils and fats), and hydrogenated oils of these. Examples of animal fats and oils include, for example, chicken fat, lard, beef tallow, sheep oil, whale oil, fish oil, egg oil, and butter. Examples of fish oil include, for example, tuna oil, bonito oil, sardine oil, mackerel oil, salmon oil, and cod oil. Examples of vegetable oils and fats include, for example, rapeseed oil, rice bran oil, safflower oil, sunflower oil, olive oil, peanut oil, palm oil, coconut oil, soybean oil, corn oil, cottonseed oil, sesame oil, grapeseed oil, and Perilla frutescens oil. As oil or fat used as the coating material, hydrogenated oil is preferred. For example, oil in the form of liquid at ordinary temperature can be hardened (hydrogenated), and used as the coating material. Specific examples of hydrogenated oil include, for example, hydrogenated oils of vegetable oils such as hydrogenated rapeseed oil, hydrogenated palm oil, and hydrogenated soybean oil. Preferred examples of hydrogenated oils include extreme hydrogenated oils. Specific examples of extreme hydrogenated oil include, for example, extreme hydrogenated oils of vegetable oils such as extreme hydrogenated rapeseed oil, extreme hydrogenated palm oil, and extreme hydrogenated soybean oil.

Examples of emulsifier include monoglycerin fatty acid esters, polyglycerin fatty acid esters, sucrose fatty acid esters, sorbitan fatty acid esters, propylene glycol fatty acid esters, monoglycerin organic acid esters, and monoglyceryl phosphates. The term “monoglycerin fatty acid ester” refers to a compound consisting of glycerin and an aliphatic acid bonding to hydroxyl group of the glycerin via ester bond. The term “polyglycerin fatty acid ester” refers to a compound consisting of a polyglycerin and an aliphatic acid bonding to hydroxyl group of the polyglycerin via ester bond. The term “sucrose fatty acid ester” is a compound consisting of sucrose and an aliphatic acid bonding to hydroxyl group of the sucrose via ester bond. Preferred examples of emulsifier include monoglycerin fatty acid esters and polyglycerin fatty acid esters.

The molecular structure of the emulsifier (for example, type of constituent fatty acid, esterification rate, esterification position, etc. in the case of monoglycerin fatty acid ester; degree of polymerization of polyglycerin, polymerization form of polyglycerin (linear, cyclic, or branched), type of constituent fatty acid, esterification rate, esterification position, etc. in the case of polyglycerin fatty acid ester; type of constituent fatty acid, esterification rate, esterification position, etc. in the case of sucrose fatty acid ester) can be appropriately determined depending on various conditions such as desired melting point.

When the emulsifier is a fatty acid ester, examples of the constituent fatty acid include, for example, an aliphatic acid having 8 to 24 carbon atoms. The constituent fatty acids may be a saturated fatty acid, or may be an unsaturated fatty acid. Specific examples of the aliphatic acid having 8 to 24 carbon atoms include, for example, caprylic acid, lauric acid, myristic acid, palmitic acid, stearic acid, oleic acid, behenic acid, and erucic acid. As the constituent fatty acid, one kind of aliphatic acid may be used, or two or more kinds of aliphatic acids may be used in combination. For example, two or more kinds of aliphatic acids may bond to one molecule of polyglycerin or one molecule of sucrose via ester bonds. When the emulsifier is a polyglycerin fatty acid ester, degree of polymerization (average degree of polymerization) of polyglycerin may be, for example, 4 to 20, or 8 to 12. The degree of polymerization (average degree of polymerization) of polyglycerin shall be calculated on the basis of the hydroxyl value of the polyglycerin. The hydroxyl value of the polyglycerin shall be measured according to Japanese Industrial Standard JIS K 0070:1992.

As the coating material, a commercial product may be used, or a material obtained by appropriately producing it may be used.

The shape of the coating material is not particularly limited so long as a desired effect (for example, bitter taste-suppressing effect) can be obtained.

When the step B explained later is performed in the present invention, a solid material is used as the coating material. The shape of such a coating material as a solid is not particularly limited, but examples thereof include tabular shape, flaky shape, and granular shape. When the coating material has a granular shape, the mean particle diameter D50 thereof is not particularly limited, and it may be, for example, 100 μm or smaller, 80 μm or smaller, 60 μm or smaller, or 50 μm or smaller. The mean particle diameter D50 of the coating material, for example, may be preliminarily adjusted to be within such a range of the mean particle diameter D50 as mentioned above, or may be adjusted to be within such a range of the mean particle diameter D50 as mentioned above by grinding by mixing in the step B.

The coating material can be produced by a conventional method. The coating material can be produced by, for example, an extraction method, enzymatic method, chemical synthesis method, or a combination of these. For example, an oil or fat can be produced by collecting them from agricultural, fishery, and livestock products containing the oil or fat. Further, for example, a monoglycerin fatty acid ester can be produced by bonding an aliphatic acid to glycerin via an ester bond. Further, for example, a polyglycerin fatty acid ester can be produced by bonding an aliphatic acid to a polyglycerin via an ester bond. Further, for example, a sucrose fatty acid ester can be produced by bonding an aliphatic acid to sucrose via an ester bond. The coating material may be purified to a desired extent. For example, as the coating material, a material having a purity of 50% (w/w) or higher, 70% (w/w) or higher, 90% (w/w) or higher, or 95% (w/w) or higher may be used.

### Other Ingredients

The type of the other ingredient (ingredient other than the raw material core particle and coating material) is not particularly limited so long as a desired effect (for example, bitter taste-suppressing effect) can be obtained. Examples of the other ingredient include such ingredients to be blended in foods, drinks, seasonings, or drugs as mentioned above. As the other ingredient, one kind of ingredient may be used, or two or more kinds of ingredients may be used in combination.

### Step A

The method of the present invention comprises the step of mixing a raw material core particle and a coating material by stirring at a temperature not lower than the melting point of the coating material (step A). A granulated product is formed by the step A. The step A may be performed in a batch manner, or may be performed continuously.

The amounts of the raw materials subjected to the step A are not particularly limited, and can be appropriately determined according to various conditions such as throughput of the stirring machine to be used. The quantitative ratio of the raw materials subjected to the step A is not particularly limited so long as a desired effect (for example, bitter taste-suppressing effect) can be obtained. The quantitative ratio of the raw materials subjected to the step A can be appropriately determined according to various conditions such as composition and size of the raw materials.

The amount of the raw material core particle subjected to the step A (used amount of the raw material core particle) in terms of weight ratio based on the total amount of the raw materials, for example, may be 50% (w/w) or higher, 70% (w/w) or higher, or 80% (w/w) or higher, may be 98% (w/w) or lower, 95% (w/w) or lower, or 90% (w/w) or lower, or may be within a range defined by a combination of the foregoing ranges. Specifically, the amount of the raw material core particle subjected to the step A (used amount of the raw material core particle) in terms of weight ratio based on the total amount of the raw materials may be, for example, 50 to 98% (w/w), or 70 to 95% (w/w). The amount of the raw material core particle subjected to the step A (used amount of the raw material core particle) in terms of weight ratio of the bitter taste ingredient contained in the raw material core particle based on the total amount of the raw materials, for example, may be 30% (w/w) or higher, 40% (w/w) or higher, 50% (w/w) or higher, 60% (w/w) or higher, 70% (w/w) or higher, or 80% (w/w) or higher, may be 98% (w/w) or lower, 95% (w/w) or lower, 90% (w/w) or lower, 80% (w/w) or lower, 70% (w/w) or lower, 60% (w/w) or lower, or 50% (w/w) or lower, or may be within a range defined by an uncontradictory combination of the foregoing ranges. Specifically, the amount of the raw material core particle subjected to the step A (used amount of the raw material core particle) in terms of weight ratio of the bitter taste ingredient contained in the raw material core particle based on the total amount of the raw materials may be, for example, 30 to 98% (w/w), or 40 to 95% (w/w).

The amount of the coating material subjected to the step A (used amount of the coating material) in terms of weight ratio based on the total amount of the raw materials, for example, may be 2% (w/w) or higher, 5% (w/w) or higher, or 10% (w/w) or higher, may be 30% (w/w) or lower, 25% (w/w) or lower, 20% (w/w) or lower, 18% (w/w) or lower, 15% (w/w) or lower, 12% (w/w) or lower, or 10% (w/w) or lower, or may be within a range defined by an uncontradictory combination of the foregoing ranges. Specifically, the amount of the coating material subjected to the step A (used amount of the coating material) in terms of weight ratio based on the total amount of the raw materials may be, for example, 2 to 30% (w/w), 2 to 20% (w/w), 2 to 10% (w/w), or 5 to 20% (w/w). For example, when the mean particle diameter D50 of the raw material core particle is 80 μm or smaller, 75 μm or smaller, 70 μm or smaller, 65 μm or smaller, or 60 μm or smaller, when it is larger than 60 μm, larger than 65 μm, larger than 70 μm, larger than 75 μm, or larger than 80 μm, or when it is within a range defined by an uncontradictory combination of the foregoing ranges, the amount of the coating material subjected to the step A (used amount of the coating material) in terms of weight ratio based on the total amount of the raw materials may be chosen to be within any of the ranges exemplified above. For example, when the mean particle diameter D50 of the raw material core particle is 80 μm or smaller, 75 μm or smaller, 70 μm or smaller, 65 μm or smaller, or 60 μm or smaller, especially when the mean particle diameter D50 of the raw material core particle is 75 μm or smaller, the amount of the coating material subjected to the step A (used amount of the coating material) in terms of weight ratio based on the total amount of the raw materials may be 2 to 30% (w/w), or 5 to 20% (w/w). Further, for example, when the mean particle diameter D50 of the raw material core particle is larger than 60 μm, larger than 65 μm, larger than 70 μm, larger than 75 μm, or larger than 80 μm, especially when the mean particle diameter D50 of the raw material core particle is larger than 75 μm, the amount of the coating material subjected to the step A (used amount of the coating material) in terms of weight ratio based on the total amount of the raw materials may be 2 to 10% (w/w).

When a material containing such an ingredient as the bitter taste ingredient or the coating material is used, the amount referred to in the descriptions concerning such an ingredient as the bitter taste ingredient or the coating material shall be the amount of the ingredient itself contained in the material, unless especially indicated. That is, for example, when a material containing such an ingredient as the bitter taste ingredient or the coating material is used, the amount used and contained amount (concentration) of such an ingredient as the bitter taste ingredient or the coating material shall be calculated on the basis of the amount of the ingredient itself contained in the material, unless especially indicated.

The raw materials (for example, the raw material core particle and coating material) may be subjected to the step A, for example, after they are mixed. That is, the method of the present invention may comprise a step B of preliminarily mixing the raw materials (for example, the raw material core particle and coating material) prior to the step A. The means for mixing the raw materials is not particularly limited. Examples of the means for mixing the raw materials include, for example, mixing by stirring and mixing by inversion. That is, the step B may be, for example, a step of mixing the raw materials by stirring. The step B can be performed by using, for example, a mixing machine. Examples of the mixing machine include such stirring machines as mentioned later. The conditions for the step B are not particularly limited so long as the raw materials are mixed to a desired extent. In the step B, granulation may or may not advance. As for the temperature, the step B is preferably performed at a temperature lower than the melting point of the coating material. That is, the step B may be, for example, a step of mixing (for example, mixing by stirring) the raw materials at a temperature lower than the melting point of the coating material. For example, after the step B is performed at a temperature lower than the melting point of the coating material, the step A may be performed. For example, the temperature can be increased during the step B. Specifically, for example, the temperature may be increased from a temperature lower than the melting point of the coating material to the melting point of the coating material during the step B. More specifically, for example, the step B may be started at a temperature lower than the melting point of the coating material, and the temperature may be increased to the melting point of the coating material. In such a case, the period before the temperature reaches the melting point of the coating material may be regarded as the period of the step B, and the period after the temperature reaches the melting point of the coating material may be regarded as the period of the step A. That is, the step A may be started by increasing the temperature during the step B as described above. The period of the step B is not particularly limited. The step B can be performed, for example, until the temperature is increased to a temperature higher than the melting point of the coating material. The step B can also be performed, for example, until the raw material core particle and the coating material are uniformly dispersed to a certain extent. In the case of mixing by stirring, the period of the step B may be, for example, 1 minute or longer, 3 minutes or longer, or 5 minutes or longer. In the case of mixing by inversion, the period of the step B may be, for example, 5 minutes or longer, 10 minutes or longer, or 20 minutes or longer. The mixing speed (for example, stirring speed or inversion speed) used in the step B can be appropriately determined. For example, when the step B is performed by mixing by stirring, the description concerning the rotation number for stirring used in the step A can be applied mutatis mutandis to the rotation number for stirring (stirring speed) used in the step B. The rotation number for stirring (stirring speed) used in the step B may be or may not be the same as the rotation number for stirring used in the step A. The rotation number for stirring (stirring speed) used in the step B may be, for example, 1400 to 2000 rpm in the scale of New Speed Kneader NSK-150S (Okada Seiko Co., Ltd.). The step B and the step A may be or may not be performed in the same vessel.

The step A is performed at a temperature not lower than the melting point of the coating material. That is, the temperature used in the step A is a temperature not lower than the melting point of the coating material. The temperature used in the step A may be higher than the melting point of the coating material by, for example, 2° C. or more, 5° C. or more, 10° C. or more, 15° C. or more, or 20° C. or more. Although the temperature used in the step A varies depending on the melting point of the coating material to be used, it may be, for example, 100° C. or lower, 90° C. or lower, 80° C. or lower, or 70° C. or lower. The temperature used in the step A may be, for example, within a range defined by a combination of the aforementioned ranges. Although it is preferred that the temperature is within the aforementioned range over the whole period of the step A, it may be temporarily outside the aforementioned range. That is, the expression that “the temperature of the step A is in a certain range” used for the present invention does not necessarily mean that the temperature is within the certain range over the whole period of the step A, and also includes situation that the temperature temporarily becomes outside the range. The period defined by the term “temporary” refers to a period of 20% or less, 15% or less, 10% or less, 5% or less, 3% or less, or 1% or less of the whole period of the step A. For example, in the step A, the temperature may temporarily decrease to a temperature lower than the melting point of the coating material. The temperature may decrease after completion of the step A. The temperature may decrease to, for example, ordinary temperature after completion of the step A.

The method for controlling the temperature (for example, method for increasing the temperature) is not particularly limited so long as the temperature can be maintained within a desired range. The temperature may be controlled directly or indirectly, or may be controlled directly and indirectly. For example, by heating a vessel in which stirring is performed (stirring tank explained later), the temperature can be directly controlled (for example, increased). The means for heating the stirring tank is not particularly limited, so long as a means that can heat the inside of the stirring tank is chosen. The heating means may be incorporated in the stirring tank, or may be provided outside the stirring tank. For example, by covering the stirring tank with a jacket for heating, and heating the jacket, the inside of the stirring tank can be heated from the outside. Further, for example, by stirring the raw materials (shear by a stirrer), the temperature can be indirectly controlled (for example, increased). That is, by using the heat generated by stirring of the raw materials, the temperature can be indirectly controlled (for example, increased). That is, the temperature can be controlled (for example, increased) by, for example, heating of the stirring tank, stirring of the raw materials, or a combination of them. For example, when the temperature can be maintained in a desired range by stirring of the raw materials, the stirring tank may be or may not be further heated. Specifically, for example, when the step B is performed by mixing by stirring, the temperature may be increased from a temperature lower than the melting point of the coating material to a temperature not lower than the melting point of the coating material by heating of the stirring tank, stirring of the raw materials, or a combination of them during the step B to thereby start the step A.

The stirring method is not particularly limited so long as a desired effect (for example, bitter taste-suppressing effect) can be obtained. As the stirring method, for example, a known method can be used. The stirring can be performed in an appropriate vessel. The vessel in which stirring is performed is also referred to as “stirring tank”. The shape and size of the stirring tank are not particularly limited so long as a desired effect (for example, bitter taste-suppressing effect) can be obtained. The shape of the stirring tank may be, for example, a cylindrical shape, spindle shape, or a shape consisting of a combination of the foregoing shapes. The stirring tank may be of, for example, vertical type or horizontal type. The stirring tank may have a section of, for example, a circular shape, elliptical shape, or polygonal shape. The “section” referred to herein means a horizontal section in the case of stirring tank of vertical type, or a vertical section in the case of stirring tank of horizontal type. The section preferably has a circular shape. The stirring can be performed by rotating a stirrer (also referred to as impeller). Designs of the stirrer such as shape, size, installation number, installation position, and installation direction are not particularly limited so long as a desired effect (for example, bitter taste-suppressing effect) can be obtained. The stirrer may have, for example, a rod-like shape, tabular shape, propeller shape, helical shape, or a shape consisting of a combination of these. In particular, a stirrer having a shape that gives a high shearing force is effective for controlling the temperature (for example, increasing the temperature). The size of the stirrer in terms of the length from the rotation axis to the tip of the stirrer (namely, rotation radius of the tip portion of the stirrer), for example, may be 0.1 m or longer, 0.2 m or longer, 0.3 m or longer, or 0.5 m or longer, may be 2 m or shorter, 1.5 m or shorter, 1 m or shorter, 0.7 m or shorter, 0.5 m or shorter, or 0.3 m or shorter, or may be within a range defined by an uncontradictory combination of the foregoing ranges. Specifically, the size of the stirrer may be, for example, 0.2 to 1 m in terms of the length from the rotation axis to the tip of the stirrer. The stirrer can be installed so that it can rotate around a predetermined rotation axis as the center. The stirrer may be provided, for example, at only one position on the rotation axis, or may be provided at two or more positions on the rotation axis. Only one rotation axis may be provided, or two or more rotation axes may be provided. The rotation axis may be provided at any position in the stirring tank. The rotation axis may be provided, for example, at the center of the stirring tank. For example, when a stirring tank of vertical type is used, by providing a vertical rotation axis at the center of the stirring tank, and supplying the raw materials from an upper part of the stirring tank, the raw materials can be moved downward while they are stirred, and a formed granulated product can be collected at a lower part of the stirring tank.

The stirring can be performed by using a stirring machine. Such a stirring machine is provided with a stirring tank and a stirrer. The stirring machine may be further provided with such a means for controlling temperature (for example, heating means) as described above. The stirring machine is constituted so that the raw materials can be supplied to the stirring tank, and the formed granulated product can be discharged from the stirring tank. For example, the stirring machine may separately have a port for feeding the raw materials and a port for discharging the formed granulated product, or may have an opening that serves as both a port for feeding the raw materials and a port for discharging the formed granulated product. It is preferred that the stirring machine separately has a port for feeding the raw materials and a port for discharging the formed granulated product. Specifically, the stirring machine may be constituted so that, for example, the raw materials are charged from a feed port provided at an upper part of the stirring machine, the raw materials are stirred in the stirring tank, and the formed granulated product is discharged from a discharge port provided at a lower part of the stirring machine. Examples of the stirring machine include stirring granulation machines. Examples of the stirring granulation machine include various batch type stirring machines and various continuous stirring machines. Specific examples of the stirring machine include, for example, high speed stirring type mixing granulation machines (NMG-5L, NMG-65H, etc., Nara Machinery Co., Ltd.), Nara Hybridization Systems (those of NHS series (for example, NHS-0) etc., Nara Machinery Co., Ltd.), New Speed Kneader (those of NSK series etc., Okada Seiko Co., Ltd.), Flexomix high impact mixers (FXD-250 etc., Hosokawa Micron CORP.), and Vertical Granulators (Powrex CORP.).

These stirring means and stirring machines can be used not only for the step A, but also for, for example, the step B performed by mixing by stirring.

The rotation number for stirring (stirring speed) used in the step A is not particularly limited so long as a desired effect (for example, bitter taste-suppressing effect) can be obtained. The rotation number for stirring used in the step A can be appropriately determined according to various conditions such as the type of the stirring machine to be used. The rotation number for stirring used in the step A in terms of the circumferential speed of the stirrer (namely, revolving speed at the tip of the stirrer), for example, may be 4 m/s or higher, 5 m/s or higher, 7 m/s or higher, or 10 m/s or higher, may be 20 m/s or lower, 17 m/s or lower, 15 m/s or lower, 14 m/s or lower, 13 m/s or lower, 12 m/s or lower, 11 m/s or lower, or 10 m/s or lower, or may be within a range defined by an uncontradictory combination of the foregoing ranges. Specifically, the rotation number for stirring in terms of the circumferential speed of the stirrer used in the step A may be, for example, 4 to 20 m/s, 10 to 20 m/s, or 4 to 12 m/s. For example, when the volume of the stirring machine is 60 L or smaller, 50 L or smaller, 40 L or smaller, 30 L or smaller, 20 L or smaller, 10 L or smaller, 7 L or smaller, 5 L or smaller, or 3 L or smaller, when it is larger than 3 L, larger than 5 L, larger than 7 L, larger than 10 L, larger than 20 L, larger than 30 L, larger than 40 L, larger than 50 L, or larger than 60 L, or when it is within a range defined by an uncontradictory combination of the foregoing ranges, the rotation number for stirring used in the step A may be selected to be within any of the ranges exemplified above. For example, when the volume of the stirring machine is 60 L or smaller, 50 L or smaller, 40 L or smaller, 30 L or smaller, 20 L or smaller, 10 L or smaller, 7 L or smaller, 5 L or smaller, or 3 L or smaller, the rotation number for stirring used in the step A may be 10 to 20 m/s in terms of the circumferential speed of the stirrer. For example, when the volume of the stirring machine is larger than 3 L, larger than 5 L, larger than 7 L, larger than 10 L, larger than 20 L, larger than 30 L, larger than 40 L, larger than 50 L, or larger than 60 L, the rotation number for stirring used in the step A may be 4 to 12 m/s in terms of the circumferential speed of the stirrer. For example, when the volume of the stirring machine is within a range defined by an uncontradictory combination of the ranges of larger than 3 L, larger than 5 L, larger than 7 L, larger than 10 L, larger than 20 L, larger than 30 L, larger than 40 L, or larger than 50 L, and 60 L or smaller, 50 L or smaller, 40 L or smaller, 30 L or smaller, 20 L or smaller, 10 L or smaller, 7 L or smaller, or 5 L or smaller, the rotation number for stirring used in the step A may be 4 to 20 m/s in terms of the circumferential speed of the stirrer. Further, for example, when the volume of the stirring machine is within a range defined by an uncontradictory combination of the ranges of larger than 3 L, larger than 5 L, larger than 7 L, larger than 10 L, larger than 20 L, larger than 30 L, larger than 40 L, or larger than 50 L, and 60 L or smaller, 50 L or smaller, 40 L or smaller, 30 L or smaller, 20 L or smaller, 10 L or smaller, 7 L or smaller, or 5 L or smaller, the rotation number for stirring used in the step A as the circumferential speed of the stirrer may be N [m/s] or higher, M [m/s] or lower, or N to M [m/s], wherein N=(−6x+588)/57, M=(−8x+1164)/57, and x is the volume of the stirring machine [L]. The rotation number for stirring (stirring speed) used in the step A may be, for example, 1400 to 2000 rpm in the scale of New Speed Kneader NSK-150S (Okada Seiko Co., Ltd.). Although it is preferred that the rotation number for stirring is in the range mentioned above over the whole period of the step A, it may be temporarily outside the range mentioned above. That is, the expression that “the rotation number for stirring (stirring speed) used in the step A is in a certain range” used for the present invention does not necessarily mean that the rotation number for stirring is within the certain range over the whole period of the step A, and also includes situation that the rotation number for stirring temporarily becomes outside the range. The period defined by the term “temporary” refers to a period of 20% or less, 15% or less, 10% or less, 5% or less, 3% or less, or 1% or less of the whole period of the step A. For example, the stirring may be temporarily stopped. That is, the stirring may be performed continuously or intermittently. That is, the stirring may be performed once, or twice or more times. Here, stirring once started and then stopped is considered stirring of “one time”. During the process of continuous stirring, conditions for the stirring such as rotation number for stirring may be or may not be constant. When the stirring is performed twice or more times, the conditions of stirring such as rotation number for stirring and period of stirring may be or may not be the same among the two or more times of stirring. The stirring can be performed, for example, until a granulated product is formed. The stirring period (period of the step A), for example, may be 1 minute or longer, 2 minutes or longer, 3 minutes or longer, 5 minutes or longer, 7 minutes or longer, or 10 minutes or longer, may be 150 minutes or shorter, 120 minutes or shorter, 90 minutes or shorter, 60 minutes or shorter, 50 minutes or shorter, or 30 minutes or shorter, or may be within a range defined by an uncontradictory combination of the foregoing ranges. Specifically, the stirring period (period of the step A) may be, for example, 2 to 150 minutes, 2 to 120 minutes, 2 to 90 minutes, 3 to 90 minutes, 5 to 60 minutes, or 7 to 30 minutes.

By performing the step A as described above, a granulated product can be obtained.

Formation of a desired granulated product can be confirmed by, for example, measuring the particle size of the granulated product (D50, D90/D10 etc.). Formation of a desired granulated product can also be confirmed by, for example, confirming reduction of the bitter taste of the raw material core particle.

2. Granulated product of the present invention

The granulated product of the present invention is a granulated product having the following characteristics (A) and (B):

(A) mean particle diameter D50 is 50 μm or larger;

(B) non-uniformity of particle diameter D90/D10 is 14.998×(D50 (μm)−49)^{-0.295} or lower.

The mean particle diameter D50 of the granulated product of the present invention is 50 μm or larger. The mean particle diameter D50 of the granulated product of the present invention, for example, may be 60 μm or larger, 80 μm or larger, 100 μm or larger, 200 μm or larger, 300 μm or larger, 500 μm or larger, 700 μm or larger, or 1000 μm or larger, or may be 5000 μm or smaller, 3000 μm or smaller, 2000 μm or smaller, 1500 μm or smaller, 1200 μm or smaller, 1000 μm or smaller, 900 μm or smaller, 800 μm or smaller, 700 μm or smaller, 600 μm or smaller, or 500 μm or smaller. The mean particle diameter D50 of the granulated product of the present invention may be within a range defined by an uncontradictory combination of the foregoing ranges. Specifically, the mean particle diameter D50 of the granulated product of the present invention may be, for example, 50 to 1200 μm, 50 to 1000 μm, 50 to 900 μm, 200 to 1000 μm, or 300 to 900 μm. The “mean particle diameter D50” means a particle diameter at a volume-basis integrated value of 50% in the particle size distribution obtained by the laser diffraction/scattering method. The mean particle diameter D50 can be measured with, for example, a laser diffraction particle size distribution measuring apparatus (particle size distribution measuring apparatus based on the laser diffraction/scattering method), such as MICROTRAC HRA (Nikkiso Co., Ltd.) and Partica LA-960 Wet (Horiba, Ltd.).

The non-uniformity of particle diameter D90/D10 of the granulated product of the present invention is 14.998×(D50 (μm)−49)^{0.0295} or lower. The non-uniformity of particle diameter D90/D10 of the granulated product of the present invention may be 14.998×D50 (μm)^{-0.307} or lower. “D90” and “D10” mean particle diameters at volume-based integrated values of 90% and 10% in the particle size distribution obtained by the laser diffraction/scattering method, respectively. The D90/D10 value is 1 or larger, and a D90/D10 value closer to 1 means more uniform particle size distribution. D90 and D10 can be measured with, for example, a laser diffraction particle size distribution measuring apparatus (particle size distribution measuring apparatus based on the laser diffraction/scattering method), such as MICROTRAC HRA (Nikkiso Co., Ltd.) and Partica LA-960 Wet (Horiba, Ltd.).

Ingredient(s) contained in the granulated product of the present invention is/are not particularly limited so long as a desired effect can be obtained. The ingredient(s) contained in the granulated product of the present invention can be appropriately determined depending on various conditions such as use of the granulated product of the present invention. Examples of the ingredient(s) contained in the granulated product of the present invention include, for example, a bitter taste ingredient, coating material, and another ingredient. That is the granulated product of the present invention, for example, may contain a bitter taste ingredient, may contain a coating material, or may contain a bitter taste ingredient and a coating material. The granulated product of the present invention may or may not consist of, for example, a bitter taste ingredient and a coating material. The granulated product of the present invention may or may not consist of, for example, a bitter taste ingredient, a coating material, and another ingredient. When the granulated product of the present invention contains a bitter taste ingredient and a coating material, a bitter taste-suppressing effect can possibly be obtained in the granulated product of the present invention.

Although the mechanism that provides the bitter taste-suppressing effect in the granulated product of the present invention is not fully elucidated, it is estimated that the fact that the granulated product has the characteristics (A) and (B) mentioned above means that the bitter taste ingredient is uniformly coated with the coating material, exposure of the bitter taste ingredient can be thereby suppressed, and the bitter taste-suppressing effect can be obtained as a result.

The bitter taste ingredient is as explained above. The bitter taste ingredient may be contained in the granulated product of the present invention in a state that the bitter taste ingredient forms the raw material core particle mentioned above. That is, a particle containing the bitter taste ingredient may be contained in the granulated product of the present invention, and the bitter taste ingredient may be thereby contained in the granulated product of the present invention. As the bitter taste ingredient, one kind of ingredient may be used, or two or more kinds of ingredients may be used. When two or more kinds of ingredients are used as the bitter taste ingredient, two or more kinds of the ingredients may or may not coexist in one particle of the granulated product of the present invention.

The coating material is as explained above. As the coating material, one kind of ingredient may be used, or two or more kinds of ingredients may be used. When two or more kinds of ingredients are used as the coating material, two or more kinds of the ingredients may or may not coexist in one particle of the granulated product of the present invention.

The type of the other ingredient contained in the granulated product of the present invention (ingredient other than the bitter taste ingredient and coating material) is not particularly limited so long as a desired effect (for example, bitter taste-suppressing effect) can be obtained. Examples of the other ingredient include such ingredients to be blended in foods, drinks, seasonings, or drugs as mentioned above. As the other ingredient, one kind of ingredient may be used, or two or more kinds of ingredients may be used in combination. When two or more kinds of ingredients are used as the other ingredient, two or more kinds of ingredients may or may not coexist in one particle of the granulated product of the present invention.

The contained amount(s) (concentration(s)) of the ingredient(s) in the granulated product of the present invention is/are not particularly limited so long as a desired effect (for example, bitter taste-suppressing effect) can be obtained.

The contained amount (concentration) of the bitter taste ingredient in the granulated product of the present invention, for example, may be 30% (w/w) or higher, 40% (w/w) or higher, 50% (w/w) or higher, 70% (w/w) or higher, or 80% (w/w) or higher, may be 98% (w/w) or lower, 95% (w/w) or lower, 90% (w/w) or lower, 80% (w/w) or lower, 70% (w/w) or lower, or 50% (w/w) or lower, or may be within a range defined by an uncontradictory combination of the foregoing ranges. Specifically, the contained amount (concentration) of the bitter taste ingredient in the granulated product of the present invention may be, for example, 30 to 98% (w/w), or 40 to 95% (w/w).

The contained amount (concentration) of the coating material in the granulated product of the present invention, for example, may be 2% (w/w) or higher, 5% (w/w) or higher, or 10% (w/w) or higher, may be 30% (w/w) or lower, 25% (w/w) or lower, 20% (w/w) or lower, 18% (w/w) or lower, 15% (w/w) or lower, 12% (w/w) or lower, or 10% (w/w) or lower, or may be within a range defined by an uncontradictory combination of the foregoing ranges. Specifically, the contained amount (concentration) of the coating material in the granulated product of the present invention may be, for example, 2 to 30% (w/w), 2 to 20% (w/w), 2 to 10% (w/w), or 5 to 20% (w/w).

In the granulated product of the present invention, the bitter taste ingredient may be coated with the coating material. A part or the whole of the bitter taste ingredient may be coated with the coating material. That is, the expression that “the bitter taste ingredient is coated with the coating material” does not necessarily mean that the whole of the bitter taste ingredient is coated with the coating material, and also includes situation that a part of the bitter taste ingredient is coated with the coating material. Further, the expression that “the bitter taste ingredient is coated with the coating material” does not necessarily mean that the bitter taste ingredient is coated with the coating material alone, and also includes situation that the bitter taste ingredient is coated with a mixture of the coating material and another ingredient. That is, for example, when the granulated product of the present invention is produced by using another ingredient as the raw material in addition to the bitter taste ingredient and the coating material, the bitter taste ingredient may be coated with a mixture of the coating material and the other ingredient. The degree of the coating of the bitter taste ingredient with the coating material is not particularly limited so long as a desired effect (for example, bitter taste-suppressing effect) can be obtained. The ratio of the area of the portion where the bitter taste ingredient is exposed based on the total surface area of the granulated product of the present invention may be, for example, 50% or smaller, 30% or smaller, 20% or smaller, 10% or smaller, 5% or smaller, 3% or smaller, or 0 (zero). Further, when the bitter taste ingredient is contained in the granulated product of the present invention in a state that the bitter taste ingredient forms the raw material core particle mentioned above, the ratio of the area of the portion where the raw material core particle is exposed based on the total surface area of the granulated product of the present invention may be, for example, 50% or smaller, 30% or smaller, 20% or smaller, 10% or smaller, 5% or smaller, 3% or smaller, or 0 (zero).

The method for producing the granulated product of the present invention is not particularly limited. The granulated product of the present invention can be produced by, for example, the method of the present invention described above. That is, one embodiment of the granulated product of the present invention may be a granulated product produced by the method of the present invention.

Other features of the invention will become apparent in the course of the following descriptions of exemplary embodiments which are given for illustration of the invention and are not intended to be limiting thereof.

### EXAMPLES

In the examples, a step equivalent to the step B is also referred to as “premixing step”, and a step equivalent to the step A is also referred to as “stirring mixing step”.

### Example 1: Examination of Particle Diameter of Raw Material Core Particle

In this example, granulated products were produced by using a raw material core particle containing amino acids and a coating material as the raw materials, and relation of the mean particle diameter D50 of the raw material core particle and the bitter taste-suppressing effect in the granulated products was examined. The amino acids and coating materials used are shown in Tables 1 to 3.

(1) Experiments Using Raw Material Core Particle Having Mean Particle Diameter D50 Smaller than 50 μm

The conditions for the manufacture of the granulated products are shown in Table 1. First, the raw material core particle and the coating material were subjected to the premixing step. The premixing step was started at ordinary temperature, and the temperature was increased to a temperature higher than the melting point of the coating material. The period of the premixing step was changed depending on the temperature-increasing method, and it was 12 minutes in the case of jacket heating (indicated as A in Table 1), or 70 to 90 minutes when the heat generated by stirring of the raw materials was used (indicated as B in Table 1). Then, the stirring mixing step was performed at a temperature higher than the melting point of the coating material to obtain granulated products. The premixing step and the stirring mixing step were performed by stirring mixing using New Speed Kneader NSK-150S (volume was 2.6 L, Okada Seiko Co., Ltd.) in combination with a high shearing type impeller. In the tables, “Amino acid MIX1” means a mixture containing about 40% (w/w) of leucine, about 11% (w/w) of isoleucine, about 11% (w/w) of valine, and other six kinds of essential amino acids as the remainder, which mixture was ground to have a predetermined mean particle diameter D50. In the tables, “Amino acid MIX2” means a mixture of leucine, isoleucine, and valine at a ratio of 2:1:1, which mixture was ground to have a predetermined mean particle diameter D50. The grinding was performed by using Pulverizer AP-1 (Hosokawa Micron CORP.). In the tables, the values of “14.998×D50^{-0.307}” are the values calculated from the measured values of the mean particle diameter D50. As for “Judgment of particle size distribution”, a D90/D10 value of granulated product not higher than 14.998×D50 (μm)^{-0.307} was judged “good”, and a value out of this range was judged “bad”. The obtained granulated products were subjected to measurement of particle size and evaluation of bitter taste-suppressing effect. The measurement of the particle size of the raw material core particle and the granulated products showing a D50 smaller than 500 μm was performed by using MICROTRAC HRA (Nikkiso Co., Ltd.). The measurement of the particle size of the granulated products showing a D50 of 500 μm or larger was performed by using Partica LA-960 Wet (Horiba, Ltd.). The organoleptic evaluation of the bitter taste-suppressing effect was performed as follows.

Two persons of special panelists ingested each granulated product (0.5 g in terms of the amount of the raw material core particle), and scored the intensity of the bitter taste felt at the time of the ingestion, and the averages of the scores were considered as intensity of the bitter taste. The bitter taste of 0.5 g of the raw material core particle not granulated was scored 10 points, and bitter taste that can be hardly sensed was scored 1 point. The bitter taste-suppressing effect in each granulated product was evaluated by four-grade evaluation according to the criteria mentioned below.

### Judgment Criteria:

x: No bitter taste-suppressing effect (bitter taste intensity score is 7.5 points or higher and 10 points or lower)

Δ: Certain bitter taste-suppressing effect (bitter taste intensity score is 4.5 points or higher and lower than 7.5 points)

∘: High bitter taste-suppressing effect (bitter taste intensity score is 2 points or higher and lower than 4.5 points)

⊚: Extremely high bitter taste-suppressing effect (bitter taste intensity score is 1 point or higher and lower than 2 points)

The production method of the granulated products and the evaluation method of the granulated products were the same in the following experiments, unless especially indicated.

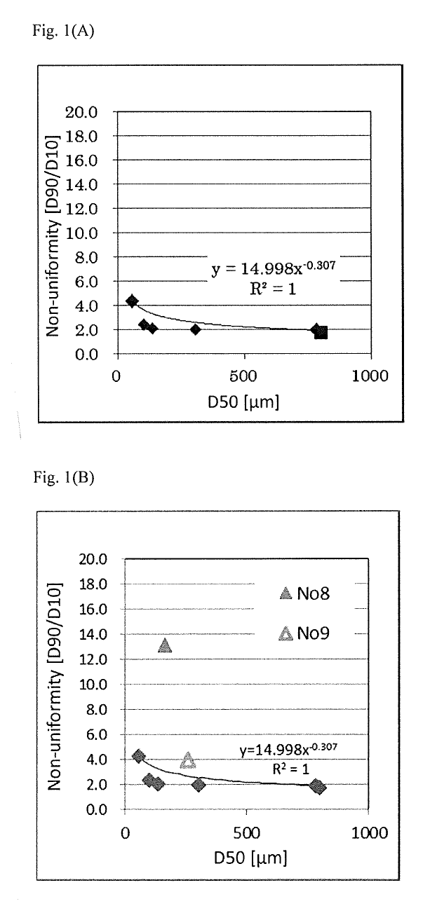

The results are shown in Table 1 and FIG. 1 (A). It became clear that an objective particle size distribution and high bitter taste-suppressing effect can be obtained by using a raw material core particle having a mean particle diameter D50 smaller than 50 μm.

TABLE 1

| | | | | | | Conditions for manufacture of granulated products | | | | |
|---|---|---|---|---|---|---|---|---|---|---|
| | Raw materials | | | | | Mean particle | | | | Period of |
| | Raw material | Coating material | | Composition (%) | | diameter D50 of | Temperature- | Circumferential | Temperature | stirring |
| | core particle | | Melting | Coating | Amino | raw material core | increasing | speed of stirrer | of stirring | mixing |
| No | Amino acid | Type | point | material | acid | particle (μm) | method | (m/s) | mixing step | step |
| 1 | Amino acid | Extreme hydrogenated | 68° C. | 7.5 | 92.5 | 36 | B | 15 | 68° C. or | 20 min |
| | MIX1 | rapeseed oil | | | | | | | higher | |
| 2 | Amino acid | Extreme hydrogenated | 68° C. | 10 | 90 | 36 | B | 15 | 68° C. or | 20 min |
| | MIX1 | rapeseed oil | | | | | | | higher | |
| 3 | Amino acid | Extreme hydrogenated | 68° C. | 11 | 89 | 36 | B | 15 | 68° C. or | 20 min |
| | MIX1 | rapeseed oil | | | | | | | higher | |
| 4 | Amino acid | Extreme hydrogenated | 68° C. | 13 | 87 | 36 | B | 15 | 68° C. or | 20 min |
| | MIX1 | rapeseed oil | | | | | | | higher | |
| 5 | Amino acid | Extreme hydrogenated | 68° C. | 17 | 83 | 36 | B | 15 | 68° C. or | 10 min |
| | MIX1 | rapeseed oil | | | | | | | higher | |
| 6 | Amino acid | Extreme hydrogenated | 68° C. | 15 | 85 | 38 | B | 15 | 68° C. or | 20 min |
| | MIX2 | rapeseed oil | | | | | | | higher | |
| 7 | Amino acid | Extreme hydrogenated | 58° C. | 13 | 87 | 36 | A | 11 | 58° C. or | 10 min |
| | MIX1 | palm oil | | | | | | | higher | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | D50 \hat{ } −0.307 | distribution | evaluation |
| 1 | 57 | 4.34 | 130 | 30 | 4.34 | Good | ◯ |
| 2 | 101 | 2.42 | 163 | 68 | 3.63 | Good | ⊚ |
| 3 | 135 | 2.10 | 197 | 94 | 3.33 | Good | ⊚ |
| 4 | 305 | 2.01 | 367 | 182 | 2.59 | Good | ⊚ |
| 5 | 786 | 1.93 | 1039 | 537 | 1.94 | Good | ⊚ |
| 6 | 800 | 1.74 | 1037 | 595 | 1.93 | Good | ⊚ |
| 7 | 348 | 2.48 | 435 | 175 | 2.49 | Good | ⊚ |

(2) Experiments Using Raw Material Core Particle Having Mean Particle Diameter D50 not Smaller than 100 μm

The stirring mixing was performed under the conditions shown in Table 2 to obtain granulated products. The period of the premixing step was changed depending on the temperature-increasing method, and it was 5 to 8 minutes in the case of jacket heating (indicated as A in Table 2), or 53 to 58 minutes when the heat generated by stirring of the raw materials was used (indicated as B in Table 2). In the experiment of No. 9, Hybridization System NHS-0 (Nara Machinery Co., Ltd.) was used as the stirring machine. The obtained granulated products were subjected to measurement of particle size and evaluation of bitter taste-suppressing effect. The results are shown in Table 2 and FIG. 1 (B). When the raw material core particle having a mean particle diameter D50 not smaller than 100 μm were used, the results of the evaluation of the particle size distribution were bad, and preferred bitter taste-suppressing effect could not be obtained.

TABLE 2

| | | | | | | Conditions for manufacture of granulated products | | | | |
|---|---|---|---|---|---|---|---|---|---|---|
| | Raw materials | | | | | Mean particle | | | | Period of |
| | Raw material | Coating material | | Composition (%) | | diameter D50 of | Temperature- | Circumferential | Temperature | stirring |
| | core particle | | Melting | Coating | Amino | raw material core | increasing | speed of stirrer | of stirring | mixing |
| No | Amino acid | Type | point | material | acid | particle (μm) | method | (m/s) | mixing step | step |
| 8 | Amino acid | Extreme hydrogenated | 68° C. | 13 | 87 | 108 | A | 15 | 68° C. or | 20 min |
| | MIX1 | rapeseed oil | | | | | | | higher | |
| 9 | Amino acid | Extreme hydrogenated | 68° C. | 15 | 85 | 114 | B | 15 | 68° C. or | 20 min |
| | MIX2 | rapeseed oil | | | | | | | higher | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | D50 \hat{ } −0.307 | distribution | evaluation |
| 8 | 164 | 13.30 | 359 | 27 | 3.13 | Bad | X |
| 9 | 260 | 4.03 | 520 | 129 | 2.72 | Bad | Δ |

### (3) Evaluation of Bitter Taste of Raw Material Core Particle

The raw material core particles used in Example 1 (1) and (2) themselves were subjected to the measurement of particle size and evaluation of bitter taste-suppressing effect. The results are shown in Table 3. All the raw material core particles showed strong bitter taste irrespective of the mean particle diameter D50.

TABLE 3

| | Raw material | Particle size | | | | | Judgment of | |
|---|---|---|---|---|---|---|---|---|
| | core particle | | | | | 14.998 * | particle size | Organoleptic |
| No | Amino acid | D50 (μm) | D90/D10 | D90 (μm) | D10 (μm) | D50 \hat{ } −0.307 | distribution | evaluation |
| 0-1 | Amino acid | 36 | 14.8 | 130 | 30 | 4.99 | Bad | X |
| | MIX1 | | | | | | | |
| 0-2 | Amino acid | 108 | 11.5 | 280 | 24 | 3.56 | Bad | X |
| | MIX1 | | | | | | | |
| 0-3 | Amino acid | 114 | 14.1 | 253 | 28 | 3.50 | Bad | X |
| | MIX2 | | | | | | | |
| 0-4 | Amino acid | 38 | 14.9 | 137 | 9 | 4.91 | Bad | X |
| | MIX2 | | | | | | | |

### Example 2: Examination of Rotation Number for Stirring (Stirring Speed)

In this example, granulated products were produced by using a raw material core particle containing amino acids and a coating material as the raw materials, and influence of the rotation number for stirring (stirring speed) was examined.

The stirring mixing was performed under the conditions shown in Table 4 to obtain granulated products. The temperature was increased by using the heat generated by stirring of the raw materials (indicated as B in Table 4), and the period of the premixing step was 180 to 210 minutes for the experiment of No. 10, or 1 to 3 minutes for the experiment of No. 11. For the experiment of No. 11, Hybridization System NHS-0 (Nara Machinery Co., Ltd.) was used as the stirring machine. The obtained granulated products were subjected to measurement of particle size and evaluation of bitter taste-suppressing effect. The results are shown in Table 4. Under the conditions of the circumferential speed of the impeller (stirrer) of 8 m/s or 60 m/s, the evaluation results of the particle size distribution of the granulated products were bad, and preferred bitter taste-suppressing effect could not be obtained.

TABLE 4

| | | | | | | Conditions for manufacture of granulated products | | | | |
|---|---|---|---|---|---|---|---|---|---|---|
| | Raw materials | | | | | Mean particle | | | | Period of |
| | Raw material | Coating material | | Composition (%) | | diameter D50 of | Temperature- | Circumferential | Temperature | stirring |
| | core particle | | Melting | Coating | Amino | raw material core | increasing | speed of stirrer | of stirring | mixing |
| No | Amino acid | Type | point | material | acid | particle (μm) | method | (m/s) | mixing step | step |
| 10 | Amino acid | Extreme hydrogenated | 68° C. | 13.0 | 87.0 | 36 | B | 8 | 68° C. or | 20 min |
| | MIX1 | rapeseed oil | | | | | | | higher | |
| 11 | Amino acid | Extreme hydrogenated | 68° C. | 13.0 | 87.0 | 36 | B | 60 | 68° C. or | 20 min |
| | MIX1 | rapeseed oil | | | | | | | higher | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | D50 \hat{ } −0.307 | distribution | evaluation |
| 10 | 36 | 32.9 | 4 | 115 | 4.99 | Bad | X |
| 11 | 13 | 10.2 | 39 | 4 | 6.76 | Bad | X |

### Example 3: Examination of Stirring Temperature

In this example, granulated products were produced by using a raw material core particle containing amino acids and a coating material as the raw materials, and influence of the stirring temperature was examined.

The stirring mixing was performed under the conditions shown in Table 5 to obtain granulated products. In Table 5, the process performed after the temperature reached the maximum temperature is indicated as “the stirring mixing step” for convenience of the explanation. The temperature was increased by using the heat generated by stirring of the raw materials (indicated as B in Table 5), and the period of the premixing step was 90 minutes for the experiment of No. 12, or 70 minutes for the experiment of No. 13. The obtained granulated products were subjected to measurement of particle size and evaluation of bitter taste-suppressing effect. The results are shown in Table 5. Under the conditions that the stirring temperature was lower than the melting point of the oil or fat, the evaluation results of the particle size distribution of the granulated products were bad, and preferred bitter taste-suppressing effect could not be obtained.

TABLE 5

| | | | | | | Conditions for manufacture of granulated products | | | | |
|---|---|---|---|---|---|---|---|---|---|---|
| | Raw materials | | | | | Mean particle | | | | Period of |
| | Raw material | Coating material | | Composition (%) | | diameter D50 of | Temperature- | Circumferential | Temperature | stirring |
| | core particle | | Melting | Coating | Amino | raw material core | increasing | speed of stirrer | of stirring | mixing |
| No | Amino acid | Type | point | material | acid | particle (μm) | method | (m/s) | mixing step | step |
| 12 | Amino acid | Extreme hydrogenated | 68° C. | 17.0 | 83.0 | 36 | B | 15 | 43° C. | 90 min |
| | MIX1 | rapeseed oil | | | | | | | | |
| 13 | Amino acid | Extreme hydrogenated | 58° C. | 13.0 | 87.0 | 36 | B | 15 | 53° C. | 70 min |
| | MIX1 | palm oil | | | | | | | | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | D50 \hat{ } −0.307 | distribution | evaluation |
| 12 | 31 | 14.1 | 113 | 8 | 5.23 | Bad | X |
| 13 | 46 | 15.0 | 135 | 9 | 4.63 | Bad | X |

### Example 4: Examination of Granulation Conditions

In this example, granulated products were produced under various conditions by using a raw material core particle containing amino acids and a coating material as the raw materials, and influence of the conditions was examined.

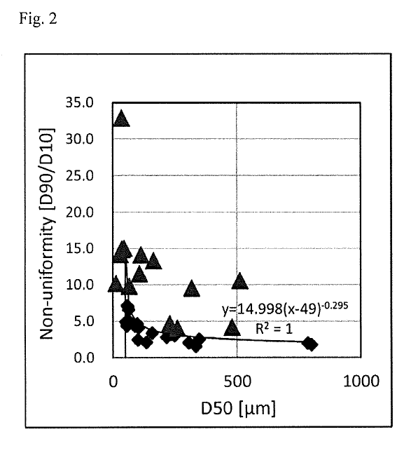

The stirring mixing was performed under the conditions shown in Tables 6 to 9 to obtain granulated products (Nos. 14 to 31). The temperature was increased by using the heat generated by stirring of the raw materials, and the period of the premixing step was 70 to 90 minutes. The obtained granulated products were subjected to measurement of particle size and evaluation of bitter taste-suppressing effect. In the tables, the values of “14.998×(D50 (μm)−49)^{-0.295}” are the values calculated from the measured values of the mean particle diameter D50. As for “Judgment of particle size distribution”, a D90/D10 value of the granulated product not higher than 14.998×(D50 (μm)−49)^{-0.295} was judged “good”, and a value out of this range was judged “bad”. In the tables, the data of the experiments of Nos. 1 to 13 and Nos. 0-1 to 0-4 obtained in Examples 1 to 3 are mentioned again on the basis of the evaluation criteria for the particle size distribution used in this example. For the data obtained in Examples 1 to 4, correlations with D50 and D90/D10 are shown in FIG. 2.

### (1) Examination by Judgment of Particle Size Distribution

The results are shown in Table 6. All the granulated products of Nos. 14 to 19 gave the results of good in the judgment of particle size distribution, and showed high bitter taste-suppressing effect. Therefore, it was suggested that granulated products that give good results according to the evaluation criteria for the particle size distribution used in this example show high bitter taste-suppressing effect. The granulated products of Nos. 1 to 7 gave the results of good also according to the evaluation criteria for the particle size distribution used in this example. The granulated products of Nos. 0-1 to 0-4 gave results of bad also according to the evaluation criteria for the particle size distribution used in this example.

TABLE 6

| | | | | | | Conditions for manufacture of granulated products | | | | |
|---|---|---|---|---|---|---|---|---|---|---|
| | Raw materials | | | | | Mean particle | | | | |
| | Raw material | Coating material | | Composition (%) | | diameter D50 of | Circumferential | Temperature | Period of | |
| | core particle | | Melting | Coating | Amino | raw material core | speed of stirrer | of stirring | stirring | Stirring |
| No | Amino acid | Type | point | material | acid | particle (μm) | (m/s) | mixing step | mixing step | machine |
| 1 | Amino acid | Extreme hydrogenated | 68° C. | 7.5 | 92.5 | 36 | 15 | 68° C. or | 20 min | NSK-150S |
| | MIX1 | rapeseed oil | | | | | | higher | | |
| 2 | Amino acid | Extreme hydrogenated | 68° C. | 10.0 | 90.0 | 36 | 15 | 68° C. or | 20 min | NSK-150S |
| | MIX1 | rapeseed oil | | | | | | higher | | |
| 3 | Amino acid | Extreme hydrogenated | 68° C. | 11.0 | 89.0 | 36 | 15 | 68° C. or | 20 min | NSK-150S |
| | MIX1 | rapeseed oil | | | | | | higher | | |
| 4 | Amino acid | Extreme hydrogenated | 68° C. | 13.0 | 87.0 | 36 | 15 | 68° C. or | 20 min | NSK-150S |
| | MIX1 | rapeseed oil | | | | | | higher | | |
| 5 | Amino acid | Extreme hydrogenated | 68° C. | 17.0 | 83.0 | 36 | 15 | 68° C. or | 10 min | NSK-150S |
| | MIX1 | rapeseed oil | | | | | | higher | | |
| 6 | Amino acid | Extreme hydrogenated | 68° C. | 15.0 | 85.0 | 38 | 15 | 68° C. or | 20 min | NSK-150S |
| | MIX2 | rapeseed oil | | | | | | higher | | |
| 7 | Amino acid | Extreme hydrogenated | 58° C. | 13.0 | 87.0 | 36 | 11 | 58° C. or | 10 min | NSK-150S |
| | MIX1 | palm oil | | | | | | higher | | |
| 14 | Amino acid | Extreme hydrogenated | 68° C. | 7.5 | 92.5 | 36 | 15 | 68° C. or | 10 min | NSK-150S |
| | MIX1 | rapeseed oil | | | | | | higher | | |
| 15 | Amino acid | Extreme hydrogenated | 68° C. | 10.0 | 90.0 | 36 | 15 | 68° C. or | 5 min | NSK-150S |
| | MIX1 | rapeseed oil | | | | | | higher | | |
| 16 | Amino acid | Extreme hydrogenated | 68° C. | 13.0 | 87.0 | 36 | 15 | 68° C. or | 4 min | NSK-150S |
| | MIX1 | rapeseed oil | | | | | | higher | | |
| 17 | Amino acid | Extreme hydrogenated | 68° C. | 11.0 | 89.0 | 36 | 15 | 68° C. or | 3 min | NSK-150S |
| | MIX1 | rapeseed oil | | | | | | higher | | |
| 18 | Amino acid | Extreme hydrogenated | 68° C. | 11.0 | 89.0 | 36 | 15 | 68° C. or | 10 min | NSK-150S |
| | MIX1 | rapeseed oil | | | | | | higher | | |
| 19 | Amino acid | Extreme hydrogenated | 68° C. | 13.0 | 87.0 | 36 | 15 | 68° C. or | 7 min | NSK-150S |
| | MIX1 | rapeseed oil | | | | | | higher | | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | (D50 − 49)\hat{ }−0.295 | distribution | evaluation |
| 1 | 57 | 4.34 | 130 | 30 | 8.24 | Good | ◯ |
| 2 | 101 | 2.42 | 163 | 68 | 4.67 | Good | ⊚ |
| 3 | 135 | 2.10 | 197 | 94 | 4.03 | Good | ⊚ |
| 4 | 305 | 2.01 | 367 | 182 | 2.92 | Good | ⊚ |
| 5 | 786 | 1.93 | 1039 | 537 | 2.14 | Good | ⊚ |
| 6 | 800 | 1.74 | 1037 | 595 | 2.13 | Good | ⊚ |
| 7 | 348 | 2.48 | 435 | 175 | 2.79 | Good | ⊚ |
| 14 | 53 | 4.88 | 127 | 26 | 9.96 | Good | ◯ |
| 15 | 65 | 4.96 | 139 | 28 | 6.62 | Good | ◯ |
| 16 | 61 | 7.00 | 133 | 19 | 7.21 | Good | ◯ |
| 17 | 58 | 7.10 | 149 | 21 | 7.84 | Good | ⊚ |
| 18 | 98 | 4.59 | 179 | 39 | 4.76 | Good | ⊚ |
| 19 | 64 | 6.57 | 138 | 21 | 6.75 | Good | ◯ |

| | Raw material | Particle size | | | | | Judgment of | |
|---|---|---|---|---|---|---|---|---|
| | core particle | | | | | 14.998 * | particle size | Organoleptic |
| No | Amino acid | D50 (μm) | D90/D10 | D90 (μm) | D10 (μm) | (D50 − 49)\hat{ }−0.295 | distribution | evaluation |
| 0-1 | Amino acid | 36 | 14.8 | 130 | 30 | — | Bad | X |
| | MIX1 | | | | | | | |
| 0-2 | Amino acid | 108 | 11.5 | 280 | 24 | 4.50 | Bad | X |
| | MIX1 | | | | | | | |
| 0-3 | Amino acid | 114 | 14.1 | 253 | 28 | 4.38 | Bad | X |
| | MIX2 | | | | | | | |
| 0-4 | Amino acid | 38 | 14.9 | 137 | 9 | — | Bad | X |
| | MIX2 | | | | | | | |

### (2) Examination of Particle Diameter of Raw Material Core Particle

The results are shown in Table 7. When the particle diameter of the raw material core particle was increased, the results of the judgment of particle size distribution became bad. However, by decreasing the amount of the coating material to be mixed, the results of the judgment of particle size distribution were changed to good even when the particle diameter of the raw material core particle was increased.

TABLE 7

| | | | | | | Conditions for manufacture of granulated products | | | | |
|---|---|---|---|---|---|---|---|---|---|---|
| | Raw materials | | | | | Mean particle | | | | |
| | Raw material | Coating material | | Composition (%) | | diameter D50 of | Circumferential | Temperature | Period of | |
| | core particle | | Melting | Coating | Amino | raw material core | speed of stirrer | of stirring | stirring | Stirring |
| No | Amino acid | Type | point | material | acid | particle (μm) | (m/s) | mixing step | mixing step | machine |
| 8 | Amino acid | Extreme hydrogenated | 68° C. | 13.0 | 87.0 | 108 | 15 | 68° C. or | 20 min | NSK-150S |
| | MIX1 | rapeseed oil | | | | | | higher | | |
| 9 | Amino acid | Extreme hydrogenated | 68° C. | 15.0 | 85.0 | 114 | 15 | 68° C. or | 20 min | NHS-0 |
| | MIX2 | rapeseed oil | | | | | | higher | | |
| 20 | Amino acid | Extreme hydrogenated | 68° C. | 6.0 | 94.0 | 100 | 15 | 68° C. or | 40 min | NSK-150S |
| | MIX1 | rapeseed oil | | | | | | higher | | |
| 21 | Amino acid | Extreme hydrogenated | 68° C. | 7.5 | 92.5 | 100 | 15 | 68° C. or | 40 min | NSK-150S |
| | MIX1 | rapeseed oil | | | | | | higher | | |
| 22 | Amino acid | Extreme hydrogenated | 68° C. | 9.0 | 91.0 | 100 | 15 | 68° C. or | 40 min | NSK-150S |
| | MIX1 | rapeseed oil | | | | | | higher | | |
| 23 | Amino acid | Extreme hydrogenated | 68° C. | 3.5 | 96.5 | 240 | 15 | 68° C. or | 8 min | NSK-150S |
| | MIX1 | rapeseed oil | | | | | | higher | | |
| 24 | Amino acid | Extreme hydrogenated | 68° C. | 13.0 | 87.0 | 90 | 15 | 68° C. or | 9 min | NSK-150S |
| | MIX1 | rapeseed oil | | | | | | higher | | |
| 25 | Amino acid | Extreme hydrogenated | 68° C. | 13.0 | 87.0 | 85 | 15 | 68° C. or | 6 min | NSK-150S |
| | MIX1 | rapeseed oil | | | | | | higher | | |
| 26 | Amino acid | Extreme hydrogenated | 68° C. | 13.0 | 87.0 | 85 | 15 | 68° C. or | 3 min | NSK-150S |
| | MIX1 | rapeseed oil | | | | | | higher | | |
| 27 | Amino acid | Extreme hydrogenated | 68° C. | 13.0 | 87.0 | 58 | 5 | 68° C. or | 80 min | NMG-65H |
| | MIX1 | rapeseed oil | | | | | | higher | | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | (D50 − 49)\hat{ }−0.295 | distribution | evaluation |
| 8 | 164 | 13.30 | 359 | 27 | 3.70 | Bad | X |
| 9 | 260 | 4.03 | 520 | 129 | 3.09 | Bad | Δ |
| 20 | 159 | 3.4 | 262 | 78 | 3.75 | Good | ⊚ |
| 21 | 217 | 2.8 | 305 | 109 | 3.31 | Good | ⊚ |
| 22 | 248 | 3.0 | 361 | 121 | 3.15 | Good | ⊚ |
| 23 | 236 | 3.2 | 380 | 120 | 3.21 | Good | ◯ |
| 24 | 512 | 10.5 | 654 | 62 | 2.45 | Bad | X |
| 25 | 480 | 4.1 | 638 | 154 | 2.50 | Bad | X |
| 26 | 229 | 4.6 | 405 | 88 | 3.24 | Bad | X |
| 27 | 334 | 1.5 | 403 | 263 | 2.83 | Good | ⊚ |

### (3) Examination of Rotation Number for Stirring (Stirring Speed)

The results are shown in Table 8. Use of a high-speed stirring type mixing granulation machine NMG-65H (volume is 65 L, Nara Machinery Co., Ltd.) as the stirring machine provided favorable granulated products with a lower stirring speed compared with use of New Speed Kneader NSK-150S (volume is 2.6 L, Okada Seiko Co., Ltd.).

TABLE 8

| | | | | | | Conditions for manufacture of granulated products | | | | |
|---|---|---|---|---|---|---|---|---|---|---|
| | Raw materials | | | | | Mean particle | | | | |
| | Raw material | Coating material | | Composition (%) | | diameter D50 of | Circumferential | Temperature | Period of | |
| | core particle | | Melting | Coating | Amino | raw material core | speed of stirrer | of stirring | stirring | Stirring |
| No | Amino acid | Type | point | material | acid | particle (μm) | (m/s) | mixing step | mixing step | machine |
| 10 | Amino acid | Extreme hydrogenated | 68° C. | 13.0 | 87.0 | 36 | 8 | 68° C. or | 20 min | NSK-150S |
| | MIX1 | rapeseed oil | | | | | | higher | | |
| 11 | Amino acid | Extreme hydrogenated | 68° C. | 13.0 | 87.0 | 36 | 60 | 68° C. or | 20 min | NSK-150S |
| | MIX1 | rapeseed oil | | | | | | higher | | |
| 27 | Amino acid | Extreme hydrogenated | 68° C. | 13.0 | 87.0 | 58 | 5 | 68° C. or | 80 min | NMG-65H |
| | MIX1 | rapeseed oil | | | | | | higher | | |
| 28 | Amino acid | Extreme hydrogenated | 68° C. | 13.0 | 87.0 | 58 | 3 | 68° C. or | 90 min | NMG-65H |
| | MIX1 | rapeseed oil | | | | | | higher | | |
| 29 | Amino acid | Extreme hydrogenated | 68° C. | 13.0 | 87.0 | 36 | 7.5 | 68° C. or | 5 min | NMG-65H |
| | MIX1 | rapeseed oil | | | | | | higher | | |
| 30 | Amino acid | Extreme hydrogenated | 68° C. | 11.0 | 89.0 | 36 | 10 | 68° C. or | 20 min | NMG-65H |
| | MIX1 | rapeseed oil | | | | | | higher | | |
| 31 | Amino acid | Extreme hydrogenated | 68° C. | 13.0 | 87.0 | 36 | 15 | 68° C. or | 80 min | NMG-65H |
| | MIX1 | rapeseed oil | | | | | | higher | | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | (D50 − 49)\hat{ }−0.295 | distribution | evaluation |
| 10 | 36 | 32.9 | 4 | 115 | — | Bad | X |
| 11 | 13 | 10.2 | 39 | 4 | — | Bad | X |
| 27 | 334 | 1.5 | 403 | 263 | 2.83 | Good | ⊚ |
| 28 | 66 | 9.8 | 147 | 15 | 6.52 | Bad | X |
| 29 | 103 | 4.1 | 195 | 48 | 4.62 | Good | ⊚ |
| 30 | 89 | 4.3 | 185 | 43 | 5.05 | Good | ⊚ |
| 31 | 318 | 9.5 | 401 | 42 | 2.88 | Bad | X |

### (4) Examination of Stirring Temperature

The results are shown in Table 9. The results for the judgment of particle size distribution of the granulated products of Nos. 12 and 13 were bad also according to the evaluation criteria for the particle size distribution used in this example.

TABLE 9

| | | | | | | Conditions for manufacture of granulated products | | | | |
|---|---|---|---|---|---|---|---|---|---|---|
| | Raw materials | | | | | Mean particle | | | | |
| | Raw material | Coating material | | Composition (%) | | diameter D50 of | Circumferential | Temperature | Period of | |
| | core particle | | Melting | Coating | Amino | raw material core | speed of stirrer | of stirring | stirring | Stirring |
| No | Amino acid | Type | point | material | acid | particle (μm) | (m/s) | mixing step | mixing step | machine |
| 12 | Amino acid | Extreme hydrogenated | 68° C. | 17.0 | 83.0 | 36 | 15 | 43° C. | 90 min | NSK-150S |
| | MIX1 | rapeseed oil | | | | | | | | |
| 13 | Amino acid | Extreme hydrogenated | 58° C. | 13.0 | 87.0 | 36 | 15 | 53° C. | 70 min | NSK-150S |
| | MIX1 | palm oil | | | | | | | | |

| | Granulated products | | | | | | |
|---|---|---|---|---|---|---|---|
| | Particle size | | | | | Judgment of | |
| | | | | | 14.998 * | particle size | Organoleptic |
| No | D50 (μm) | D90/D10 | D90 (μm) | D10 (μm) | (D50 − 49)\hat{ }−0.295 | distribution | evaluation |
| 12 | 31 | 14.1 | 113 | 8 | — | Bad | x |
| 13 | 46 | 15.0 | 135 | 9 | — | Bad | x |

### INDUSTRIAL APPLICABILITY

According to the present invention, a granulated product can be produced. According to one embodiment of the present invention, a bitter taste of a bitter taste ingredient such as branched chain amino acids can be suppressed (reduced).

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A granulated product having the following characteristics (A) and (B):
(A) mean particle diameter D50 is 50 μm or larger;
(B) non-uniformity of particle diameter D90/D10 is 14.998×(D50 (μm)−49)^{-0.295} or lower.

2. The granulated product according to claim 1, which contains a bitter taste ingredient.

3. The granulated product according to claim 1, which contains a coating material.

4. The granulated product according to claim 3, wherein the bitter taste ingredient is coated with the coating material.

5. The granulated product according to claim 2, wherein the bitter taste ingredient is an amino acid.

6. The granulated product according to claim 3, wherein the coating material consists of one or more kinds of ingredients selected from an oil or fat having a melting point of 20° C. or higher and an emulsifier having a melting point of 20° C. or higher.

7. The granulated product according to claim 2, wherein said bitter taste ingredient is present in said granulated product in an amount of 30% (w/w) or higher, based on the weight of said granulated product.

8. The granulated product according to claim 3, wherein said coating material is present in said granulated product in an amount of 2 to 30% (w/w), based on the weight of said granulated product.

9. The granulated product according to claim 1, wherein said non-uniformity of particle diameter D90/D10 is 14.998×D50 (μm)^{-0.307} or lower.

10. A method for producing a granulated product, which comprises
(A) mixing a raw material core particle and a coating material by stirring at a temperature not lower than the melting point of the coating material.

11. The method according to claim 10, wherein said raw material core particle contains a bitter taste ingredient.

12. The method according to claim 11, wherein said bitter taste ingredient is present in said raw material core particle in an amount of 30% (w/w) or higher, based on the weight of said raw material core particle.

13. The method according to claim 11, wherein said bitter taste ingredient is an amino acid.

14. The method according to claim 10, wherein the coating material consists of one or more kinds of ingredients selected from an oil or fat having a melting point of 20° C. or higher and an emulsifier having a melting point of 20° C. or higher.

15. The method according to claim 10, wherein the amount of the raw material core particle used is 80% (w/w) or larger in terms of a weight ratio based on the total amount of the raw materials of the granulated product.

16. The method according to claim 10, wherein the amount of the coating material to be used in terms of a weight ratio based on the total amount of the raw materials of the granulated product is 2 to 30% (w/w) when mean particle diameter D50 of the raw material core particle is 75 μm or smaller, or 2 to 10% (w/w) when the mean particle diameter D50 of the raw material core particle is larger than 75 μm.

17. The method according to claim 10, which comprises”
(B) mixing the raw material core particle and the coating material at a temperature lower than the melting point of the coating material prior to step A.

18. The method according to claim 17, wherein said temperature is increased during step B.

19. The method according to claim 10, wherein the period of stirring performed in step A is 2 to 150 minutes.

20. The method according to claim 10,
wherein step A is performed by using a stirring machine provided with a stirrer, and
wherein the stirring speed used in step A in terms of circumferential speed of the stirrer is 10 to 20 m/s when the volume of the stirring machine is 3 L or smaller, 4 to 12 m/s when the volume of the stirring machine is larger than 60 L, or 4 to 20 m/s when the volume of the stirring machine is larger than 3 L and not larger than 60 L.
